(19) United States
(12) Patent Application Publication
(10) Pub. No.: US 2005/0210504 A1
(43) Pub. Date: Sep. 22, 2005

(54) Apparatus and method for receiving a broadcasting service in a digital multimedia broadcasting system

(75) Inventors: Jun-Won Ko, Seoul (KR); Suk-Jin Jung, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/083,755

(22) Filed: Mar. 18, 2005

(30) Foreign Application Priority Data
Mar. 19, 2004 (KR) 18802/2004

(51) Int. Cl. G06F 3/00

(52) U.S. Cl. 725/40; 725/37; 348/563

(57) ABSTRACT

An apparatus and method are provided for receiving a broadcasting service in a digital multimedia broadcasting (DMB) system based on code division multiplexing (CDM). The broadcasting service reception apparatus and method can minimize inconvenience for a user when a receiver changes a broadcasting service. The receiver maintains existing broadcasting data stored in a buffer while changing the broadcasting service. After the data of a new broadcasting service requested by the receiver is deinterleaved while the existing broadcasting data is maintained, the deinterleaved broadcasting data is output to a screen and another output device. A reserved channel is set such that data of the requested broadcasting service can be deinterleaved.

### PRIORITY

This application claims priority to an application entitled “APPARATUS AND METHOD FOR RECEIVING A BROADCASTING SERVICE IN A DIGITAL MULTIMEDIA BROADCASTING SYSTEM”, filed in the Korean Intellectual Property Office on Mar. 19, 2004 and assigned Ser. No. 2004-18802, the contents of which are incorporated herein by reference.

### BACKGROUND OF THE INVENTION

1. Field of the Invention

The present invention relates generally to an apparatus and method for receiving a broadcasting service in a broadcasting system, and more particularly to an apparatus and method for receiving digital multimedia broadcasting (DMB).

2. Description of the Related Art

Digital broadcasting can provide high-quality images and compact disk (CD)-quality sound, and can provide users with high-level services that can replace the conventional analog broadcasting system. The digital broadcasting system is divided into a terrestrial broadcasting system and a satellite broadcasting system. The terrestrial broadcasting system provides a broadcasting service using a ground-based repeater. The satellite broadcasting system provides a broadcasting service using a satellite serving as a repeater.

Digital broadcasting uses a Motion Picture Experts Group-2 (MPEG-2) technique and an MPEG-4 technique to provide high-quality images and sounds. The two techniques compress and transfer broadcasting service traffic at a high compression rate. Because the MPEG-2 technique can transfer a large amount of information at a high compression rate, it is widely used in digital broadcasting systems. Digital broadcasting systems adopt a technique capable of providing a high compression rate to transfer a large amount of information.

Various systems are used to transfer broadcasting service traffic. One of these systems is a digital multimedia broadcasting (DMB) system. A broadcasting service capable of being provided by the DMB system will be described.

The DMB system may use five channels to provide a specific terminal with one broadcasting service. The five channels will be described with reference to FIG. 1.

FIG. 1 illustrates a structure of channels necessary to receive a broadcasting service in a terminal of the DMB system. Types and functions of channels necessary to receive the broadcasting service in the terminal of the DMB system will be described with reference to FIG. 1.

As illustrated in FIG. 1, the DMB system includes Channel-0 100 for transferring pilot information, Channel-1 102 for transferring electronic program guide (EPG) information, and Channel-2 104 for transferring conditional access system (CAS) information. The DMB system uses two broadcasting channels to transfer broadcasting traffic. In FIG. 1, the broadcasting channels are Channel-3 106 of Broadcasting A-1 and Channel-4 108 of Broadcasting A-2. Two channels are actually used for transferring the broadcasting traffic, i.e. Channel-3 106 and Channel-4 108. The DMB system is designed such that broadcasting traffic for one broadcasting service can be transferred through two channels.

When a broadcasting service is provided, the DMB system interleaves broadcasting traffic to be transferred in units of large data blocks, and transfers the interleaved broadcasting traffic. Because an encoder interleaves encoded data in units of large data blocks and transfers the interleaved encoded data, a receiver can decode broadcasting data only when having received all of the interleaved encoded data. A deinterleaving process is possible only when all of the data interleaved in the large data blocks is received, and a decoding process can be performed only when the deinterleaving process is completed. Accordingly, because a terminal of the DMB system can decode broadcasting service traffic after receiving data of a size necessary to perform the deinterleaving process, an operation for providing the broadcasting service is significantly delayed.

A delay time required to provide the broadcasting service occurs not only in a case where the terminal initiates the service, but also in a case where a user requests another channel. A case where a service is delayed according to a request for different channel broadcasting while the terminal receives a broadcasting service of a specific channel will be described in detail with reference to FIG. 2.

FIG. 2 is a timing diagram illustrating a delay time when a broadcasting service is switched in the conventional DMB system. The reason why a service is delayed when a broadcasting service is switched and the delay time will be described with reference to FIG. 2.

Referring to FIG. 2, the x-axis represents time, and the y-axis represents traffic for providing a broadcasting service. A state in which the terminal first receives Broadcasting-A 200 of the DMB service is illustrated in FIG. 2. When the user requests a broadcasting service change in the terminal receiving the broadcasting service, the terminal deletes data stored in a buffer (not illustrated) that was used to provide Broadcasting-A 200, and must then receive broadcasting data of the newly requested channel. Normally, a large amount of data is stored in the buffer to provide Broadcasting-A 200, and corresponds to a data size necessary to interleave the broadcasting data.

After deleting the data stored in the buffer, the terminal must store data in the buffer from a time point T₀₀ to a time point T₀₂ such that the user can receive Broadcasting-B 204 serving as the requested broadcasting service. An amount of data stored in the buffer must be greater than or equal to that of interleaved data such that Broadcasting-B 204 serving the requested broadcasting service can be normally provided. A time interval 202 indicating a delay time due to deinterleaving/decoding includes a time interval for storing requested broadcasting service traffic and a time interval for deinterleaving and decoding stored data. Data of Broadcasting-B 204 serving as the requested broadcasting service is continuously received during the time interval 202, but the requested broadcasting service is only provided after the time point T₀₂.

When broadcasting data is interleaved in units of large data blocks and the interleaved data is transferred, the terminal must receive all of the interleaved data to deinterleave the broadcasting data. In this case, a delay time is required which includes deinterleaving and decoding times. Accordingly, when the terminal of the DMB system with a large interleaving size desires to switch the broadcasting service, it cannot provide the broadcasting service until all the interleaved data is received. Even though the terminal has received all the data, it does not provide broadcasting during the deinterleaving and decoding time intervals. When Broadcasting-A 200 is switched to Broadcasting-B 204 in response to a request at the time point T₀₀, the reception of Broadcasting-A 200 ends, and no broadcasting is provided during the time interval 202 when Broadcasting-B 204 is being received and deinterleaved. After Broadcasting-B 204 is completely deinterleaved and decoded, Broadcasting-B 204 is output.

The DMB system interleaves broadcasting traffic in units of large data blocks so that a receiver can correct data transmission errors when a transmitter transmits data. When desiring to deinterleave and decode the data, the receiver must basically receive interleaved data. When desiring to switch the broadcasting service in the DMB system, the user is inconvenienced because no broadcasting service is provided between the time point T₀₀ and the time point T₀₂ as illustrated in FIG. 2.

### SUMMARY OF THE INVENTION

It is, therefore, an aspect of the present invention to provide an apparatus and method that can smoothly receive a broadcasting service in a terminal of a digital multimedia broadcasting (DMB) system.

It is another aspect of the present invention to provide an apparatus and method that can minimize a broadcasting interruption time when a broadcasting service change request is made in a terminal of a digital multimedia broadcasting (DMB) system.

The above and other aspects of the present invention can be achieved by an apparatus for receiving broadcasting data in a digital multimedia broadcasting (DMB) system for providing a broadcasting service using a pilot channel, an electronic program guide (EPG) channel, a conditional access system (CAS) channel, and two broadcasting service traffic channels for transferring traffic. The apparatus includes a receiver for receiving at least one reserved channel, channels for providing the broadcasting service; a decoding unit for independently deinterleaving and decoding the channels received from the receiver; and a controller for selecting an available channel among the channels for providing the broadcasting service when a channel change is requested and switching an existing broadcasting traffic to a requested broadcasting traffic when a buffering for the requested broadcasting traffic is completed; wherein the requested broadcasting traffic is received through a reserved channel and the available channel.

The above and other aspects of the present invention can be achieved by a method for receiving broadcasting data in a digital multimedia broadcasting (DMB) system for providing a broadcasting service using a pilot channel, an electronic program guide (EPG) channel, a conditional access system (CAS) channel, and two broadcasting service traffic channels for transferring traffic. The method includes selecting an available channel among the channels for providing the broadcasting service when a channel change is requested; decoding broadcasting traffic channels among the channels for providing the broadcasting service and requested broadcasting traffic associated with the channel change request using the selected available channel and a reserved channel; and changing existing broadcasting traffic to the requested broadcasting traffic when a buffering for the requested broadcasting traffic is completed.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a structure of channels necessary for receiving a broadcasting service in a terminal of a conventional digital multimedia broadcasting (DMB) system;

FIG. 2 is a timing diagram illustrating a delay time when the conventional DMB system switches the broadcasting service;

FIG. 3 is a timing diagram illustrating a concept of a broadcasting service method in a DMB system in accordance with the present invention;

FIG. 4 is a block diagram illustrating a broadcasting service receiver in the DMB system in accordance with the present invention;

FIG. 5 is a time diagram illustrating a process for processing data channel by channel in the receiver of FIG. 4 when a broadcasting service is changed in accordance with the present invention; and

FIGS. 6A and 6B are flow charts illustrating a broadcasting service reception method in the DMB system in accordance with the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

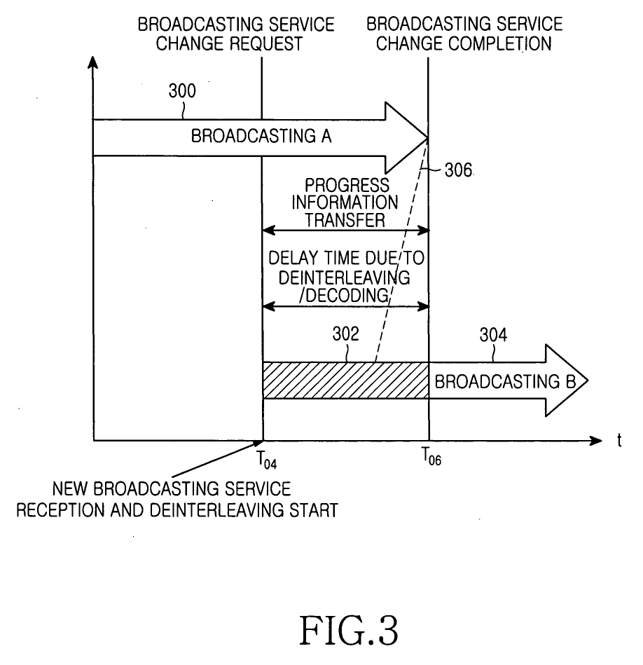

FIG. 3 is a timing diagram illustrating a concept of a broadcasting service method in a digital multimedia broadcasting (DMB) system in accordance with the present invention. For example, FIG. 3 is associated with a service change method when a service change to new Broadcasting-B 304 is requested while Broadcasting-A 300 is provided.

In FIG. 3, the x-axis represents time. Referring to FIG. 3, when a user requests a broadcasting service change at a time point T₀₄, a receiver prevents a broadcasting service from being interrupted by maintaining the existing Broadcasting-A 300 during a time interval 302 when the new Broadcasting-B 304 is deinterleaved and progress information is transferred. It can be seen that the data for Broadcasting-A 300 stored in a buffer (not illustrated) is emptied before the data for Broadcasting-B 304 is completely interleaved as indicated by reference numeral 306.

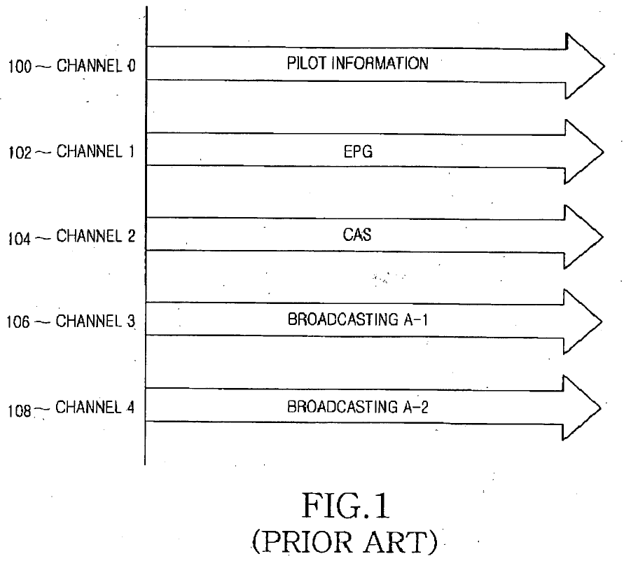

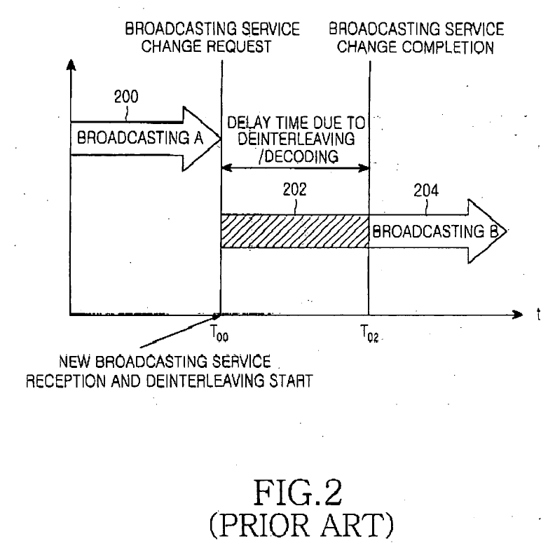

For the above operation, the present invention includes Channel 1 carrying broadcasting guide information as in the conventional channel structure of FIG. 1 and a reserved channel. Using the reserved channel, data of Broadcasting-B 304 is received from the time point T₀₄ of a broadcasting service change request to a time point T₀₆ of a broadcasting service change completion. During the time interval 302, Broadcasting-A 300 is continuously provided to the user without interruption. Accordingly, the present invention can prevent a broadcasting interruption phenomenon occurring in the conventional broadcasting system when a broadcasting service is changed.

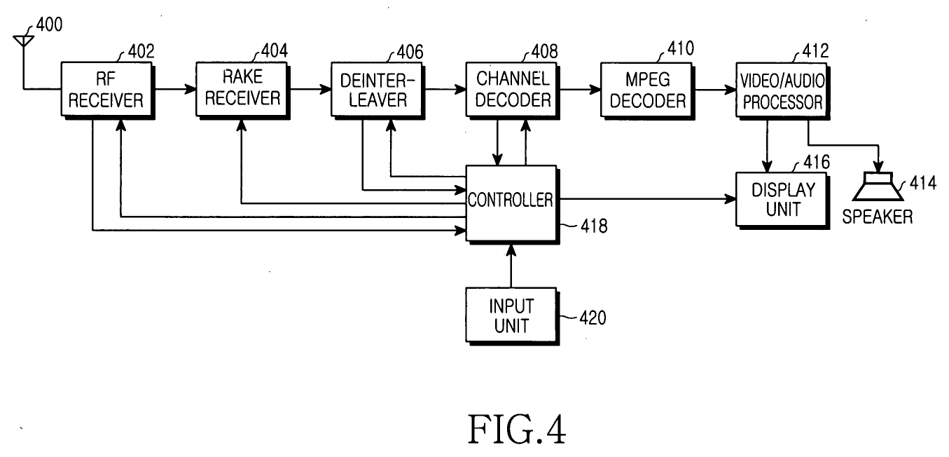

FIG. 4 is a block diagram illustrating a broadcasting service receiver in a DMB system in accordance with the present invention. The broadcasting service receiver is implemented in a mobile terminal capable of receiving a broadcasting service. It is assumed that a service change to the new Broadcasting B service is performed in response to a user request while the user is watching the Broadcasting A service.

At least one reserved channel is additionally provided such that a RAKE receiver 404 and a deinterleaver 406 can receive the new Broadcasting B in a state in which Broadcasting A is maintained during the time interval 302 of FIG. 3. In accordance with the present invention, the RAKE receiver 404 for decoding and synchronizing received broadcasting data and the deinterleaver 406 for deinterleaving the broadcasting data include the reserved channel except the five channels of FIG. 1. As the remaining components of the broadcasting service receiver, a channel decoder 408 and a Motion Picture Experts Group (MPEG) decoder 410 maintain the conventional channel structure.

When desiring to make a service change to Broadcasting B, the user selects Broadcasting B through a key manipulation of an input unit 420 in the broadcasting service receiver of FIG. 4. For this broadcasting service change, a controller 418 analyzes the RAKE receiver 404 and the deinterleaver 406 to determine if the reserved channel is available. For example, an electronic program guide (EPG) channel carrying broadcasting guide information may serve as another reserved channel when one reserved channel is provided in the RAKE receiver 404 and the deinterleaver 406.

When determining that the reserved channel of the RAKE receiver 404 and the deinterleaver 406 is available, the controller 418 controls an antenna 400 and a radio frequency (RF) receiver 402 to receive the data of Broadcasting B. The deinterleaver 406 has a significant delay time due to the buffering requirements of an internal buffer (not illustrated), and generates an address of the internal buffer using an internal counter (not illustrated). More specifically, the deinterleaver 406 can determine when desired information is output using the internal counter after the delay time of the buffering.

Accordingly, the controller 418 receives, from the deinterleaver 406, broadcasting change information indicating the start and end time points of a broadcasting service change and a progress state associated therewith. The controller 418 notifies the user of the broadcasting change information through a display unit 416. The controller 418 does not provide Broadcasting B until the internal buffer of the deinterleaver 406 is full, and continuously monitors the internal buffer of the deinterleaver 406 to determine if the internal buffer is full.

In accordance with the present invention, the channel decoder 408 internally includes a channel switch (not illustrated) for receiving channel data of a desired broadcasting service from among output data of the deinterleaver 406 and for switching the received channel data to a desired output channel. The controller 418 controls the channel switch. The channel switch can be arranged between the deinterleaver 406 and the channel decoder 408. In accordance with the present invention, the deinterleaver 406 and the channel decoder 408 are referred to as a decoding unit. For example, the data of Channel 0 of the deinterleaver 406 can be output to Channel 0 or another arbitrary channel of the channel decoder 408.

When a service change request is generated, for example, the new Broadcasting B starts to be RAKE-received and deinterleaved through Channel B selected as the reserved channel. While the internal buffer of the deinterleaver 406 is filled, existing Broadcasting A is output unmodified. When the internal buffer of the deinterleaver 406 is full and then output of Broadcasting B is enabled, the existing Broadcasting A is interrupted and Broadcasting B is output. In this case, an input channel of the channel decoder 408 is not limited to existing Channel A, and can use an arbitrary channel. When a broadcasting service is changed, the new broadcasting data can be RAKE-received and deinterleaved while the existing broadcasting is maintained.

When the internal buffer of the deinterleaver 406 is full and Broadcasting B can be output, the controller 418 interrupts the existing Broadcasting A and sends deinterleaved Broadcasting-B data to the channel decoder 408. The channel decoder 408 decodes the deinterleaved Broadcasting-B data for error correction and then outputs the decoded Broadcasting-B data to the MPEG decoder 410. Then, the decoded Broadcasting-B data is transferred to the display unit 416 and a speaker 414 through a video/audio processor 412, such that video and audio of Broadcasting B can be provided to the user.

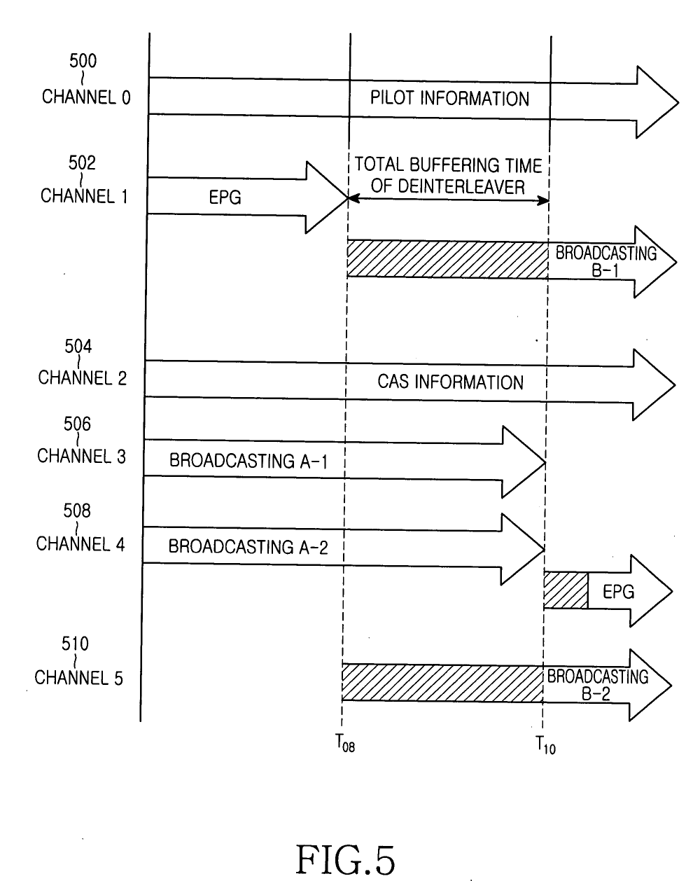

FIG. 5 is a time diagram illustrating a process for processing data channel by channel in the receiver of FIG. 4 when a broadcasting service is changed in accordance with the present invention. For example, one reserved channel, that is, Channel-5 510, is additionally provided in the RAKE receiver 404 and the deinterleaver 406 of FIG. 4. More specifically, an EPG channel, that is, Channel-1 502, is set as another reserved channel for a broadcasting service change. When the channels 506 and 508 for Broadcasting A are switched to the channels 502 and 510 for Broadcasting B, the two reserved channels are used for decoding and deinterleaving.

Functions of Channels 0 to 5 illustrated in FIG. 5 will be described. First, the user receives the channels 506 and 508 for Broadcasting A through the receiver of FIG. 4. When the user requests a service change to the channels 502 and 510 for Broadcasting B, the two reserved channels 502 and 510 are assigned as channels for video and audio data of Broadcasting B.

This embodiment assigns, as the reserved channel, the EPG channel having a lower priority, that is, a lower occupancy rate, than any other channel. Alternatively, another channel other than the EPG channel may be assigned as the reserved channel. Because Broadcasting-B data is decoded and deinterleaved through Channel-1 502 serving as the EPG channel and Channel-5 510 in accordance with the present invention, the user can continue viewing Broadcasting A while the Broadcasting-B data is deinterleaved, such that the inconvenience due to broadcasting interruption occurring in the conventional broadcasting system can be avoided.

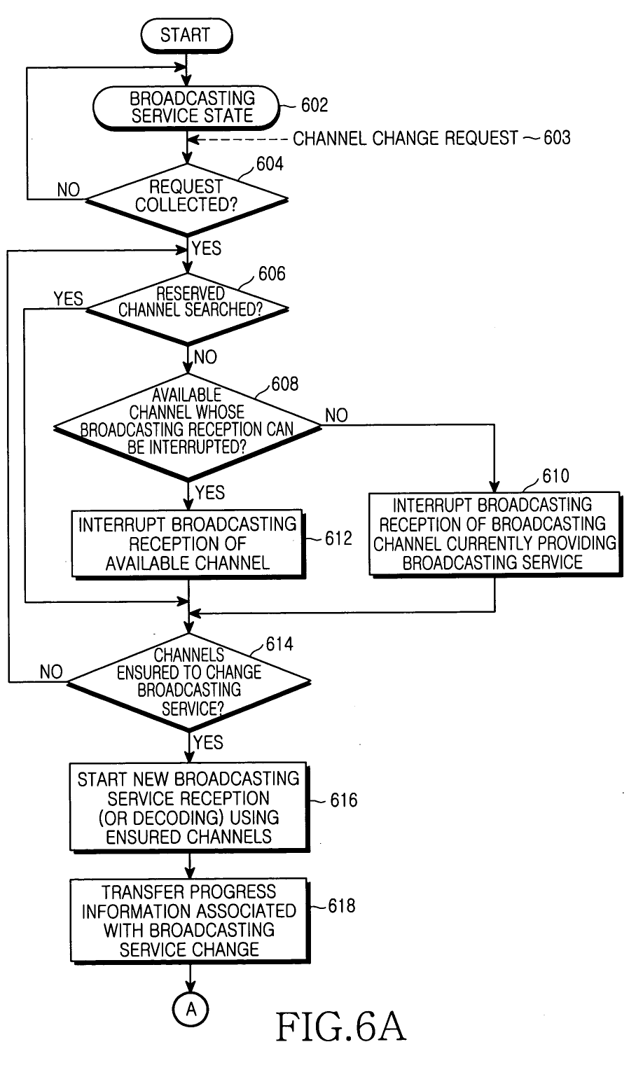

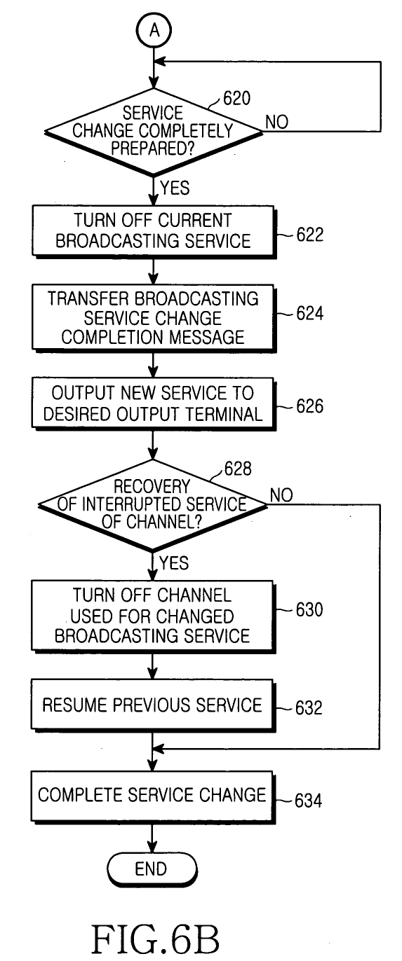

A broadcasting service reception method of the present invention in the DMB system to which the receiver of FIG. 4 is applied will be described with reference to FIGS. 6A and 6B. The method of FIGS. 6A and 6B is performed on the basis of the channel structure of FIG. 5.

While a Broadcasting-A service is provided in step 602, a broadcasting service change request is applied to the controller 418 through the input unit 420 in step 603. Then, the controller 418 collects and detects the request for a change to a service desired by the user, that is, a request for a change to a desired channel, in step 604. Then, the controller 418 analyzes the RAKE receiver 404 and the deinterleaver 406 to determine if a reserved channel is present in step 606. When it is determined that no reserved channel is present in step 606, the controller 418 determines if a channel whose broadcasting reception can be interrupted is present in a state in which a service is not affected in step 608. However, when it is determined that a reserved channel is present in step 606, the controller 418 proceeds to step 614 to determine if a number of channels necessary to change the current service have been ensured.

When an available channel whose broadcasting reception can be interrupted is present in step 608, the controller 418 proceeds to step 612 to interrupt the broadcasting reception of the available channel. However, when an available channel whose broadcasting reception can be interrupted is not present, the controller 418 proceeds to step 610 to interrupt the broadcasting reception of a broadcasting channel currently providing broadcasting. After performing step 610 or 612, the controller 418 proceeds to step 614 to ensure a number of channels necessary to change a service. After the channels necessary to change a service are ensured, the controller 418 proceeds to step 616 to begin reception and decoding of new broadcasting data using the ensured channels.

After decoding, the controller 418 proceeds to step 618 to output progress information associated with a broadcasting service change to the display unit 416. In this case, the display unit 416 outputs a predetermined guide message indicating that broadcasting will soon be changed. While the progress information associated with the broadcasting service change is transferred, the controller 418 determines if the broadcasting service change has been completely prepared in step 620. If the broadcasting service change has not been completely prepared, the progress information is continuously displayed on the display unit 416.

However, if the service change has been prepared, the controller 418 proceeds to step 622 discontinue Broadcasting A and then proceeds to step 624 to transfer a broadcasting service change completion message. After the broadcasting service change completion message is transferred, new Broadcasting B is output to a desired output terminal in step 626. After Broadcasting B is output, the controller 418 determines whether to recover a channel whose broadcasting reception has been interrupted while broadcasting is changed in step 628. If a channel whose broadcasting reception has been interrupted must be recovered, the controller 418 turns off a channel used for a changed broadcasting service in step 630, and resumes a previous service in step 632. Then, the controller 418 completes the service change in step 634. However, if a channel whose broadcasting reception has been interrupted does not need to be recovered, the controller 418 proceeds to step 634 to complete the service change.

When broadcasting is changed in a DMB system based on code division multiplexing (CDM), the present invention can avoid broadcasting service interruption of a predetermined time interval that inconveniences a user, and can simplify the configuration of a mobile terminal associated therewith.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

1. An apparatus for receiving broadcasting data in a digital multimedia broadcasting (DMB) system for providing a broadcasting service using a pilot channel, an electronic program guide (EPG) channel, a conditional access system (CAS) channel, and two broadcasting service traffic channels for transferring traffic, comprising:
a receiver for receiving data through at least one reserved channel and channels for providing the broadcasting service;
a decoding unit for independently deinterleaving and decoding the data received from the receiver; and
a controller for selecting an available channel among the channels for providing the broadcasting service when a channel change is requested, and switching an existing broadcasting traffic to a requested broadcasting traffic when a buffering for the requested broadcasting traffic is completed;
wherein the requested broadcasting traffic is received through a reserved channel and the available channel.

2. The apparatus according to claim 1, further comprising a Motion Picture Experts Group(MPEG) decoder for decoding broadcasting service traffic channels output from the decoding unit, and outputting a decoded broadcasting traffic to a display unit.

3. The apparatus according to claim 1, wherein the controller controls the decoding unit to continuously decode channels except the selected available channel among the channels for providing the one broadcasting service when the channel change is requested, and performs a control operation such that channels necessary to provide a requested broadcasting service are decoded after the channel change.

4. The apparatus according to claim 1, wherein the decoding unit is comprises of a deinterleaver and a channel decoder.

5. The apparatus according to claim 4, wherein the decoding unit further comprises:
a channel switch for switching, to the MPEG decoder, requested broadcasting traffic channels associated with the channel change request among the decoded channels.

6. The apparatus according to claim 1, wherein the receiver comprises a radio frequency (RF) receiver and a RAKE receiver for receiving broadcasting data.

7. The apparatus according to claim 1, further comprising:
the displaying unit for displaying the broadcasting traffic.

8. A method for receiving broadcasting data in a digital multimedia broadcasting (DMB) system for providing a broadcasting service using a pilot channel, an electronic program guide (EPG) channel, a conditional access system (CAS) channel, and two broadcasting service traffic channels for transferring traffic, comprising:
selecting an available channel among the channels for providing the broadcasting service when a channel change is requested;
decoding broadcasting traffic channels among the channels for providing the broadcasting service and requested broadcasting traffic associated with the channel change request using the selected available channel and a reserved channel; and
changing existing broadcasting traffic to the requested broadcasting traffic when a buffering for the requested broadcasting traffic is completed.

9. The method according to claim 8, further comprising the step of:
switching the decoded broadcasting traffic to a Motion Picture Experts Group (MPEG) decoder when a buffering for the requested broadcasting traffic is completed.

10. The method according to claim 8, further comprising the step of:
deinterleaving the channels before decoding.
